(19) United States
(12) Patent Application Publication
(10) Pub. No.: US 2002/0023007 A1
(43) Pub. Date: Feb. 21, 2002

(54) Integrated multi-vendor internet shopping mall management system including a plurality of cyber commercial agencies

(76) Inventor: Bum-hee Lee, Seoul (KR)

Correspondence Address: STAAS & HALSEY LLP, 700 11TH STREET, NW, SUITE 500, WASHINGTON, DC, 20001, US

(21) Appl. No.: 09/764,220

(22) Filed: Jan. 19, 2001

(30) Foreign Application Priority Data
Jan. 26, 2000 (KR) 00-3670

(51) Int. Cl. G06F 17/60

(52) U.S. Cl. 705/26; 705/27

(57) ABSTRACT

An integrated Internet shopping mall management system integrating Internet shopping malls, each of which are managed by respective agencies, and a management method therefor. The integrated Internet shopping mall management system includes a customer web browser receiving product order information and payment information from the customer and providing the information through the Internet; an agency web browser receiving agency product information from an agency and providing the information through the Internet, and receiving paid order information through the Internet and displaying it; a shopping mall web server forming a cyber agency shopping mall for each of a plurality of agencies; providing agency product information received from agency web browsers corresponding to respective cyber agency shopping malls, to the customer web browser; and receiving order information from the customer web browser through the Internet; and a payment server receiving order information from the shopping mall web server and, after receiving payment information from the customer web browser through the Internet, handling payment information for the order. The management system enables to provide services appropriate for regional characteristics, to customers of various regions. Also, compared to the case in which each agency manages its own web servers, maintenance and management cost is lower thanks to sharing a system for customer management, product management, order/payment handling, and when inventory in an agency cannot meet orders, then other agencies are easily linked to meet the orders.

### BACKGROUND OF THE INVENTION

1. Field of the Invention

The present invention relates to a shopping mall management method for an Internet commerce site, and more particularly, to an integrated Internet shopping mall management system which integrates Internet shopping malls, each of which was managed by an agency, and a method thereof.

2. Description of the Related Art

The computer communications network linking all the world and using a transmission control protocol/Internet protocol (TCP/IP protocol) is referred to as the Internet. The Internet allows customers to visit shops and malls which are established on the Internet and then buy goods, also known as electronic shopping. Besides the Internet's global characteristic, using Internet shopping malls saves time and expense, and has several beneficial side effects. For example, Internet shopping has the advantage of being able to enter or exit from the business easily, unlike traditional stores.

In the Internet shopping business, important factors include payment methods, diverse product development, distribution/delivery systems, as well as improvement in the infrastructure of information and communications fields, including cryptography/security technologies, authentication systems, changing legal systems, protection of personal information, communication speed, etc. However, it is difficult for one centralized Internet shopping mall to provide customers all over the nation or all over the world with services appropriate for local customers, or to prepare a distribution/delivery system satisfying customers in many localities.

### SUMMARY OF THE INVENTION

In a sales organization which has nationwide or worldwide distribution agencies, each agency can have an independent sales strategy and distribution/delivery system. Each agency can even establish and manage its own Internet shopping mall. However, in such management systems, the shopping mall of each agency needs a separate management of customers and a separate building of product information and payment systems. That is, such a management system causes resource duplication. Therefore, management of separate web servers by respective agency needs substantial expenses and labors.

To solve the above problems, a first exemplary embodiment provides an integrated Internet shopping mall management system, an integrated Internet shopping mall server system, and an integrated Internet shopping mall management method, in which web hosting is supported by the Internet shopping mall of a headquarter office and a plurality of local vendors or cyber agencies, corresponding to off-line agencies, rent shops in the Internet shopping mall so that resources, such as a customers' information, product information, and a payment system, can be shared and supported.

Additional objects and advantages of the invention will be set forth in part in the description which follows, and, in part, will be obvious from the description, or may be learned by practice of the invention.

To accomplish the above and other objects of the present invention, there is provided an exemplary integrated Internet shopping mall management system in which product order information is received at a cyber agency shopping mall corresponding to a cyber agency, which a customer selects, and the agency delivers the ordered product. The shopping mall management system includes a customer web browser receiving product order information and payment information from the customer and providing the information through the Internet; an agency web browser receiving agency product information from an agency and providing the information through the Internet, and receiving paid order information through the Internet and displaying it; a shopping mall web server forming a cyber agency shopping mall for each of a plurality of agencies; providing agency product information received from agency web browsers corresponding to respective cyber agency shopping malls, to the customer web browser; and receiving order information from the customer web browser through the Internet; and a payment server receiving order information from the shopping mall web server and, after receiving payment information from the customer web browser through the Internet, handling payment information for the order.

To accomplish the above and other objects of the present invention, there is also provided another exemplary integrated Internet shopping mall server system for providing web services in an environment connected to the Internet, the server system including an agency connecting unit for receiving agency product information from an agency web browser through the Internet, and providing paid order information to the agency web browser through the Internet; a plurality of cyber agency web servers for corresponding to a plurality of agencies, and, after receiving agency product information from the agency connecting unit, providing the information to a connected customer web browser; a customer order handling unit receiving order information from the customer web browser; and a payment server receiving payment information from the customer web browser and handling the information for the order.

To accomplish the above and other objects of the present invention, there is also provided another exemplary integrated Internet shopping mall management method in which product order information is received at a cyber agency shopping mall corresponding to a cyber agency, which a customer selects, receives product order information, and the agency delivers the ordered product, the shopping mall management method including: receiving, through the Internet, agency product information of an agency from an agency web browser corresponding to each agency; on request of a customer web browser, providing agency product information of a selected agency to the customer web browser through the Internet; receiving product order information and payment information from the customer web browser through the Internet, and handling payment for the order; and on request of the agency web browser, providing paid order information of the corresponding agency, to the agency web browser through the Internet.

### BRIEF DESCRIPTION OF THE DRAWINGS

The above objects and advantages of the present invention will become more apparent by describing in detail an exemplary embodiment thereof with reference to the attached drawings in which:

FIG. 1 is an exemplary block diagram showing the structure of an integrated Internet shopping mall management system according to the present invention;

FIG. 2 is a flowchart showing an exemplary integrated Internet shopping mall management method according to the present invention;

FIGS. 3A through 3I illustrate exemplary web pages, which support that a customer can select cyber agencies and select/order goods, in an integrated Internet shopping mall management system according to the present invention;

FIG. 4 illustrates an exemplary web page, which supports that a customer can pay a bill, in an integrated Internet shopping mall management system according to the present invention; and

FIGS. 5A through 5D illustrate exemplary web pages provided by connecting units of agencies in an integrated Internet shopping mall management system according to the present invention.

### DETAILED DESCRIPTION OF THE INVENTION

Reference will now be made to exemplary embodiments of the present invention, which will be described in detail with reference to the attached drawings. The present invention is not restricted to the following embodiments, and many variations are possible within the spirit and scope of the present invention. The embodiments of the present invention are provided in order to more completely explain the present invention to anyone skilled in the art.

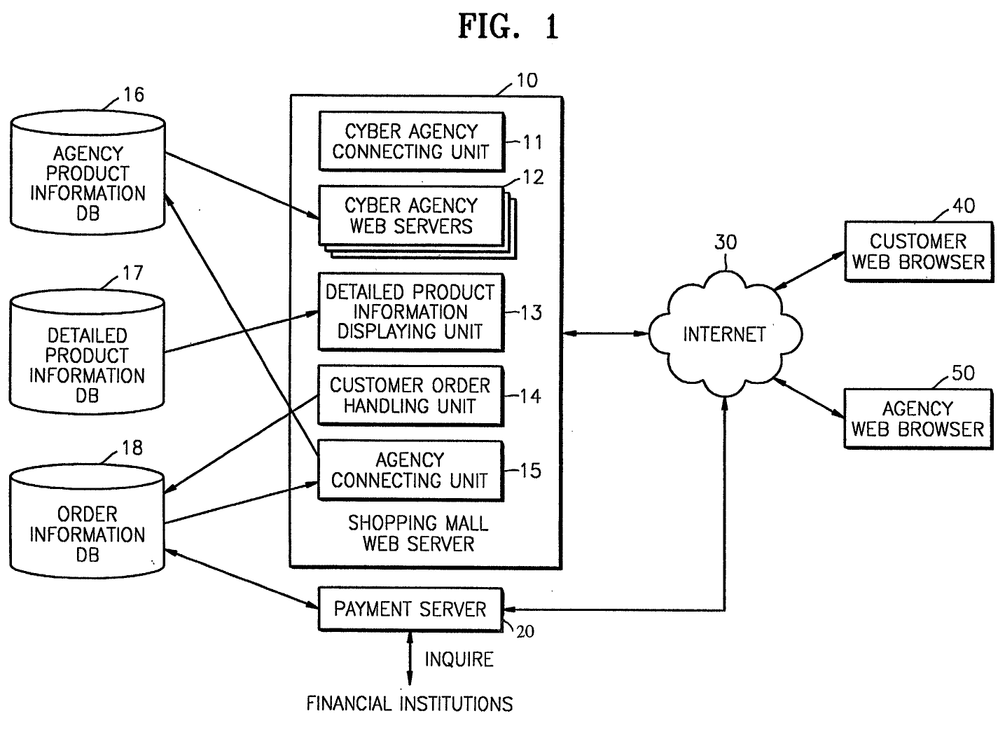

Referring to FIG. 1, a first exemplary embodiment of an integrated Internet shopping management system according to the present invention includes a shopping mall web server 10, a payment server 20, a customer web browser 40, an agency web browser 50, an agency product information database 16, a detailed product information database 17, and an order information database 18.

In the present invention, the Internet means the computer communications network linking the world and using a TCP/IP protocol. A web server including the shopping mall web server 10 generally indicates software providing web services in an environment linked to the Internet 12, but, in the present invention, is used as a concept including a computer system operating such software. Also, a web browser, including the customer web browser 40 and the agency web browser 50, generally indicates software which can read a hypertext markup language (HTML) document, a standard web document, and communicate with a web server, using a common gateway interface (CGI), but, in the present invention, is used as a concept including a computer system operating such software. Other forms of storage and retrieval are usable in the present invention.

The agency product information database 16, the detailed product information database 17, and the order information database 18 are formed by storing related data in a recording medium such as a hard disc and the like so that data can be easily added, updated, and retrieved. The databases 16-18 are used as concepts covering recording media and data stored in the recording media. Other forms of storage and retrieval are usable in the present invention.

The agency web browser 50 receives agency product information from agencies and provides the information to the shopping mall web server 10 through the Internet 30. The agency web browser 50 receives paid order information through the Internet 30 and displays the information. Then, each agency provides products to customers according to the paid order information. Here, an agency means one agency among a plurality of agencies forming an already-established distribution network for sales of products. Each agency can access the shopping mall web server 10, which is managed by a main office through the Internet 30, using its own agency web browser 50.

In the present invention, agency product information can include the list of products an agency sells, information on the agency, notices, etc. The products an agency sells is a concept covering diverse service products including transportation, beauty treatment, etc., as well as visible products including electronic products, fast foods, automobiles, etc.

The customer web browser 40 provides an environment, in which a customer can select a desired product in a desired cyber agency in the shopping mall web server 10, and receives order information and payment information for a desired product from a customer to provide the information to the shopping mall web server 10 and the payment server 20 through the Internet 30.

The shopping mall web server 10 includes cyber agency shopping malls respectively corresponding to a plurality of agencies. Each cyber agency shopping mall receives agency product information from the corresponding agency web browser 50, to provide the information to the customer web browser 40, and receives order information from the customer web browser 40 through the Internet 30 to handle the information. In an exemplary embodiment of an integrated Internet shopping mall management system according to the present invention, the shopping mall web server 10 includes a cyber agency connect unit 11, a plurality of cyber agency web servers 12, a detailed product information display unit 13, a customer order handling unit 14 and an agency connecting unit 15.

The agency connecting unit 15 receives agency product information from the agency web browser 50 through the Internet 30 to add the information to the agency product information database 16, retrieves paid order information in the order information database 18, and then provides the information to the agency web browser 50 through the Internet.

The cyber agency connecting unit 11 has hyper links to web pages provided by the plurality of cyber agency web servers 12 so that a customer can select a desired cyber agency, and connects a customer web browser 40 to a cyber agency web server 12 determined by selection information provided by the customer web browser 40. At this time, for example, the plurality of cyber agencies are divided according to regions in which each agency is actually located. Therefore, when a customer selects a region in the map displayed by the cyber agency connecting unit 11 through the customer web browser 40, hyper links of all the cyber agency web servers 12 related to the region are displayed, and the customer can select the cyber agency web server 12 corresponding to the agency the customer wants.

The plurality of cyber agency web servers 12 correspond, respectively, to a plurality of off-line agencies, access the agency product information database 16 established by the agency connecting unit, and provides through the Internet 30 agency product information to the linked customer web browser 40.

The detailed product information database 17 stores detailed information on all the products the plurality of agencies want to sell. The detailed product information display unit 13 retrieves a product, which a customer selects in the cyber agency web server 12, in the detailed product information database 17, and provides the detailed information to the customer web browser 40.

The customer order handling unit 14 receives order information from the customer web browser 40 and forms the order information database 18.

The payment server 20 provides payment information received from the customer web browser 40 to financial institutions and, when there is no problem, makes the order information stored in the order information database 18 paid order information.

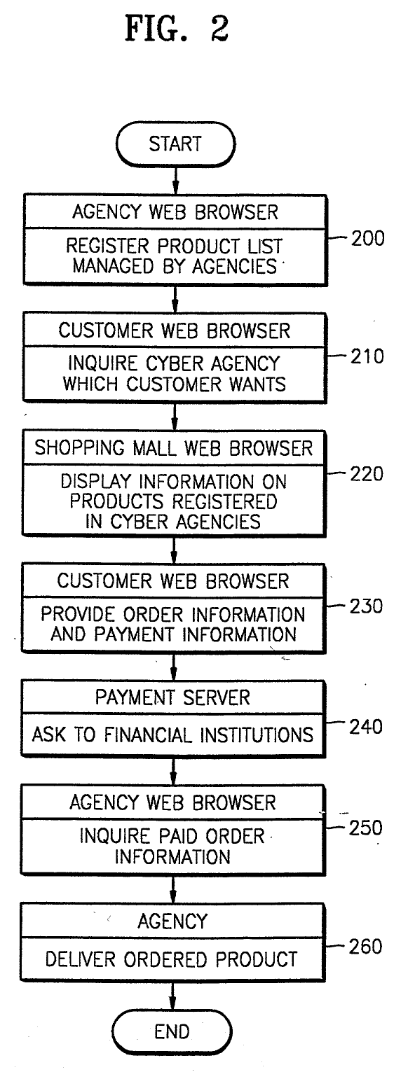

Referring to FIG. 2, the operation of the present invention will now be explained.

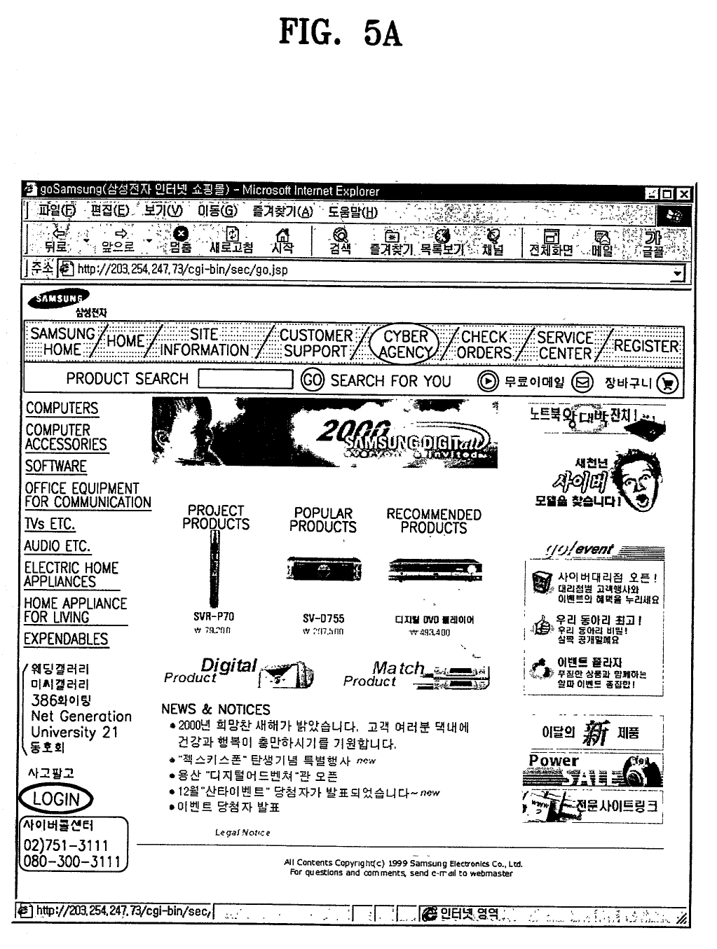

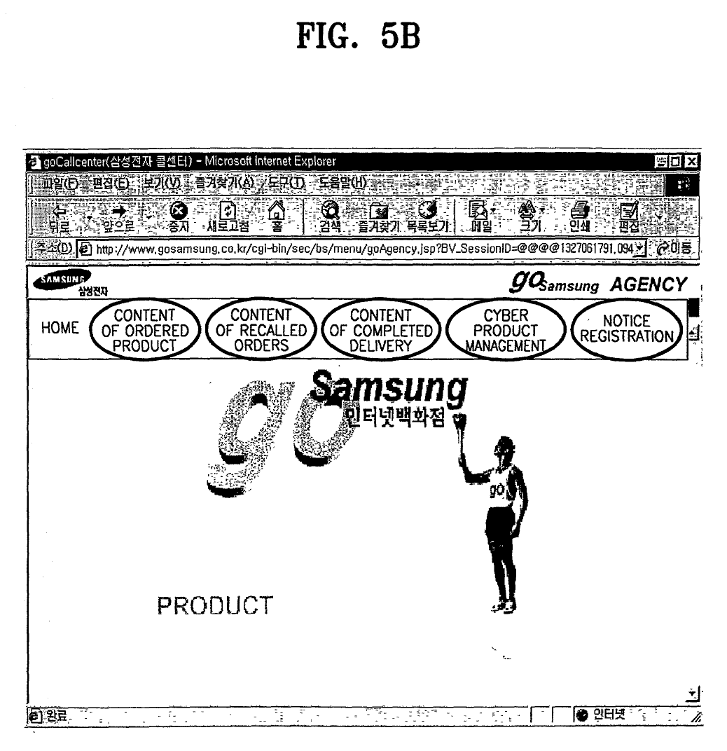

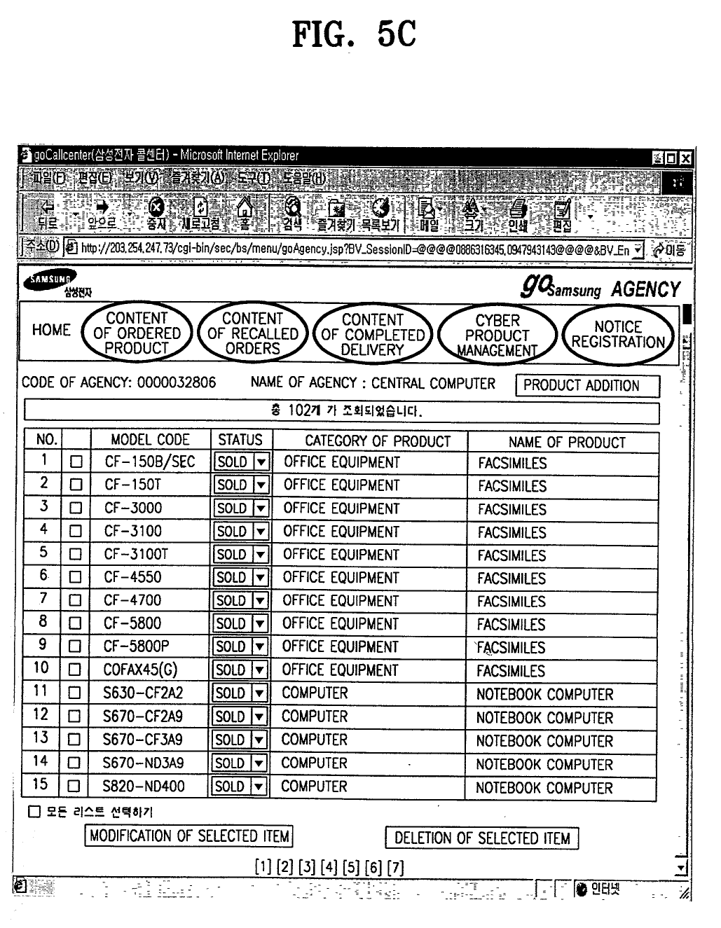

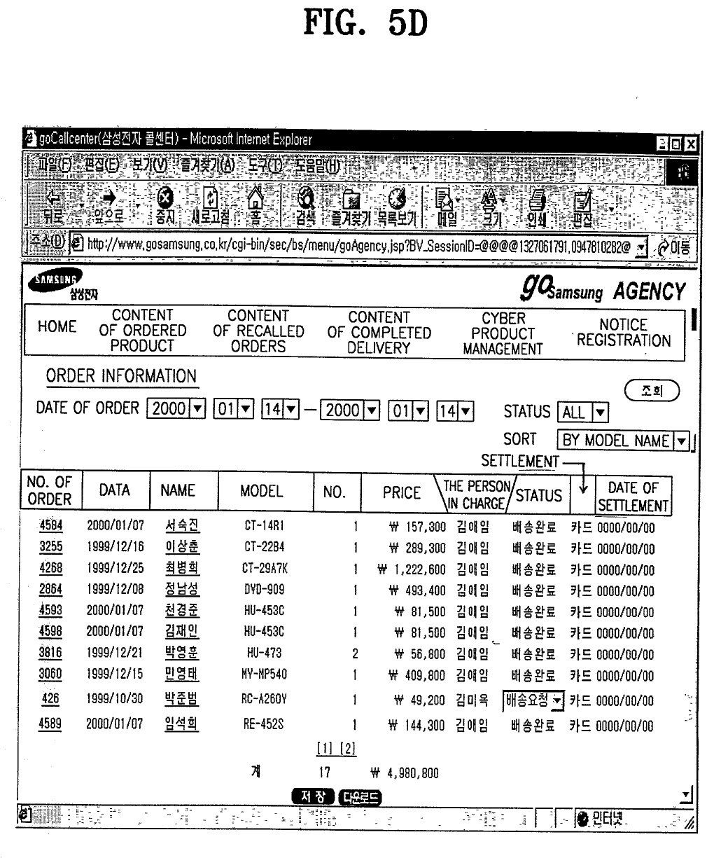

First, using its own agency web browser 50, each agency accesses the home page of the shopping mall web server 10 according to the present invention, shown in FIG. 5A, and can access the agency connecting unit 15, by selecting “LOGIN” 600 which is shown in FIG. 5A. Referring to the screen shown in FIG. 5B, the agency connecting unit 15 provides functions such as “content of ordered product” 610, “content of recalled orders” 620, “content of completed delivery” 630, “cyber product management” 640, and “notice registration” 650. When an agency selects “cyber product management” 640, the screen of FIG. 5C is displayed in the agency web browser 50, and the agency can register the list of products it wants to sells through the screen in step 200. This can be done by clicking on product addition 660, modification of selected item 670, or the deletion of selected item 680. Thus, registration of the list of products each agency wants to sell is exemplified. Also, notices informing customers of events prepared by each agency can be stored in the agency product information database 16 in a similar manner.

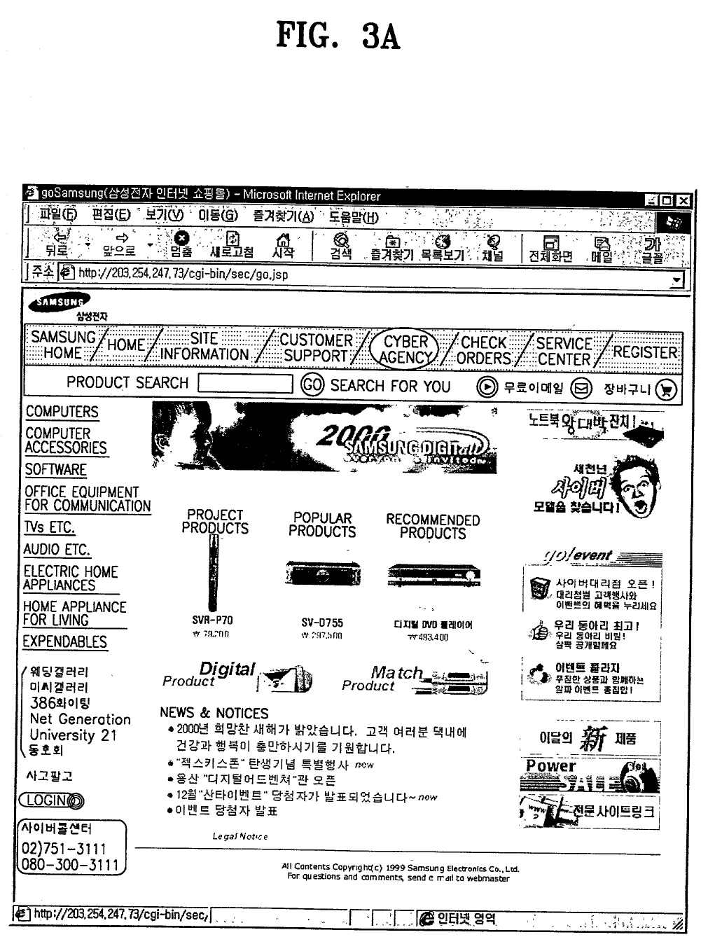

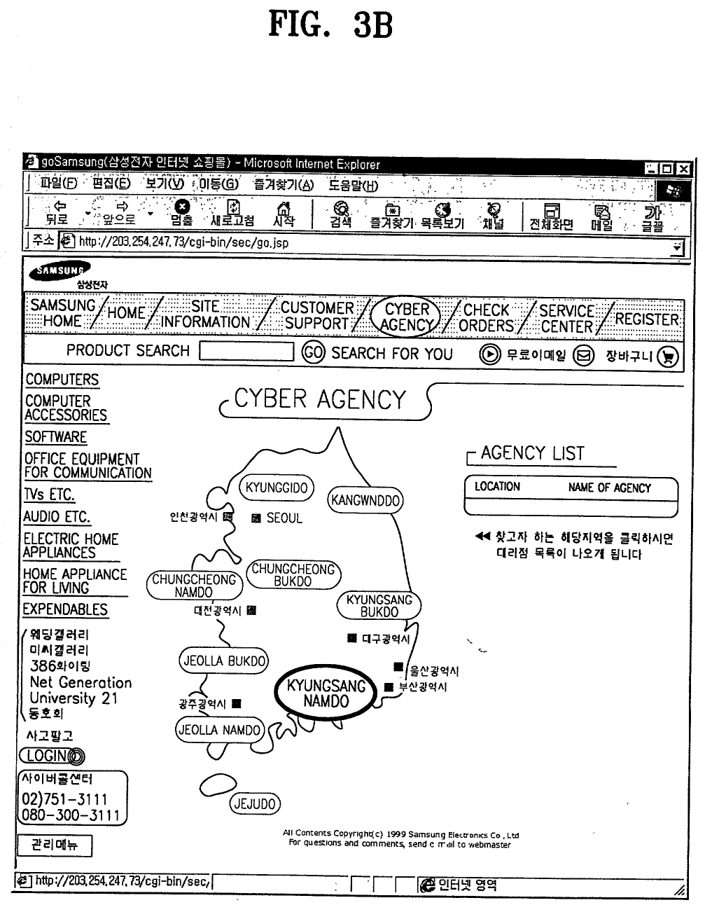

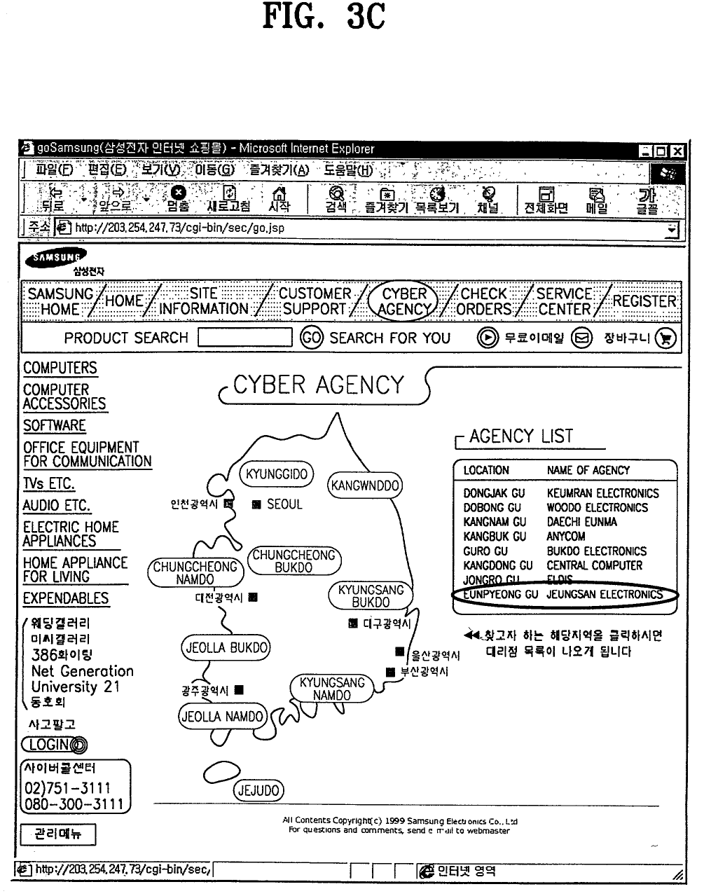

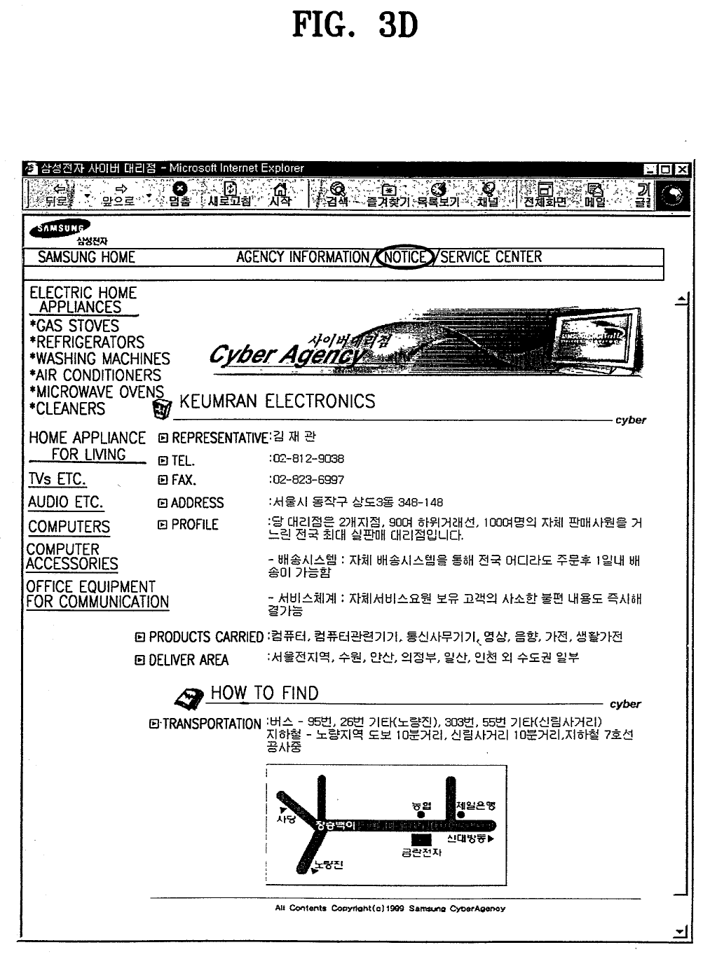

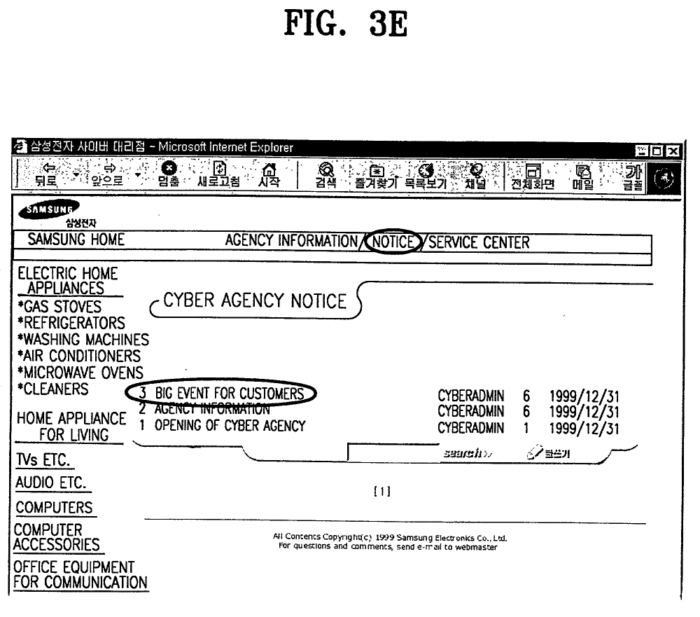

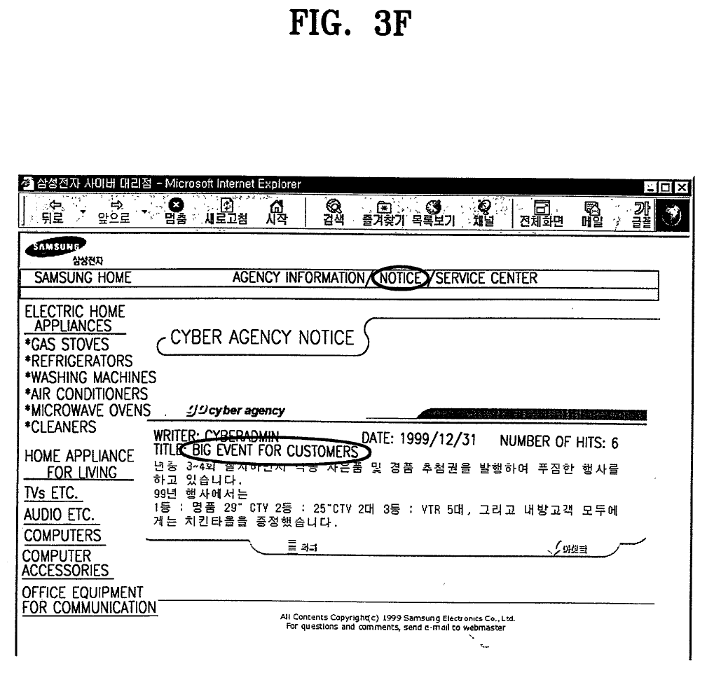

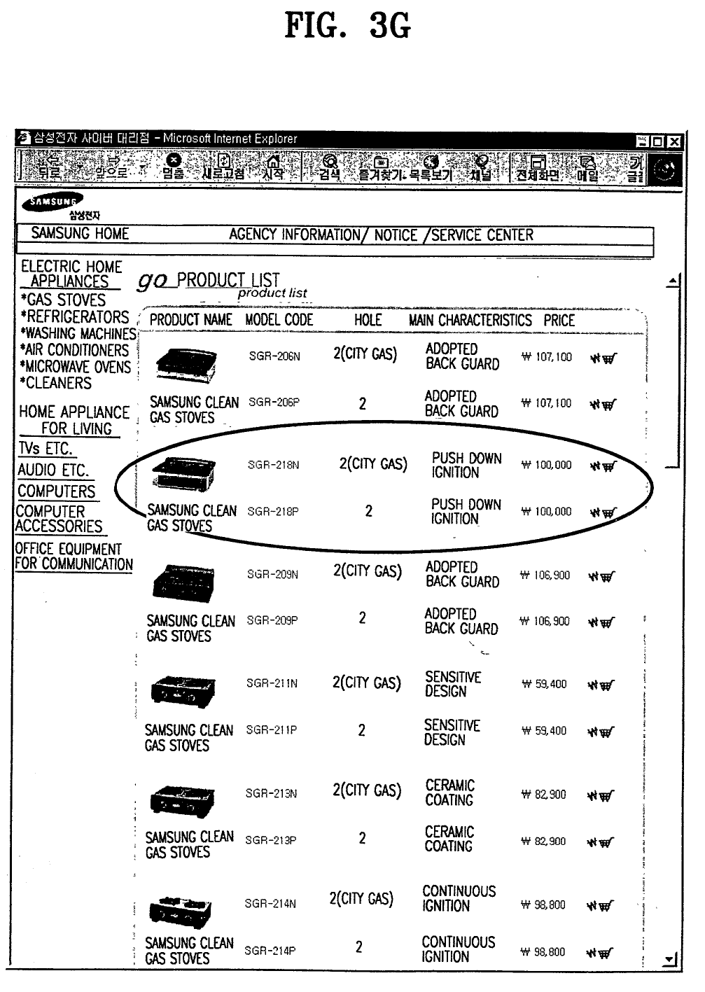

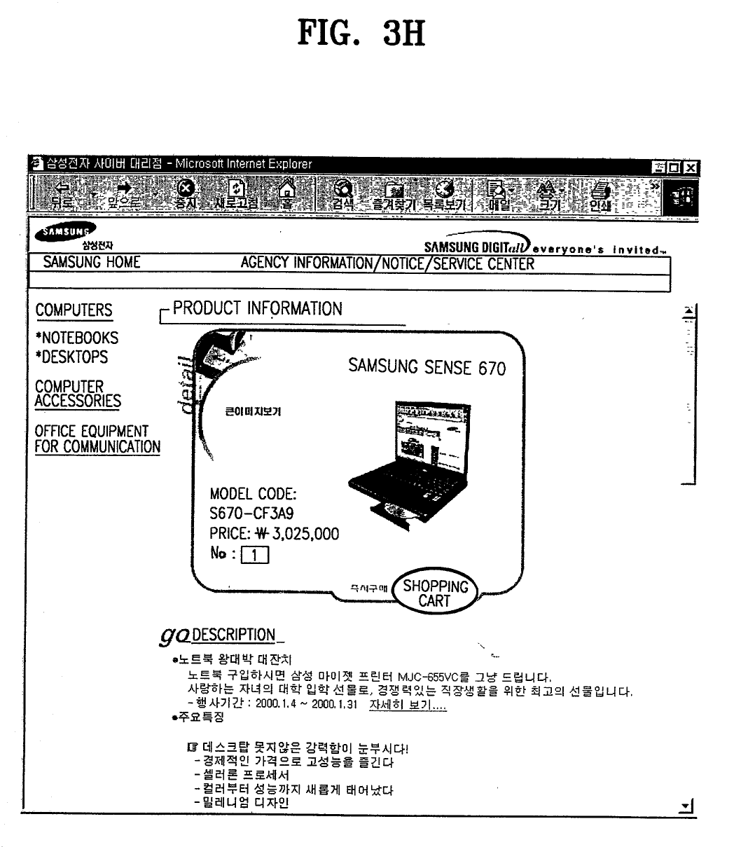

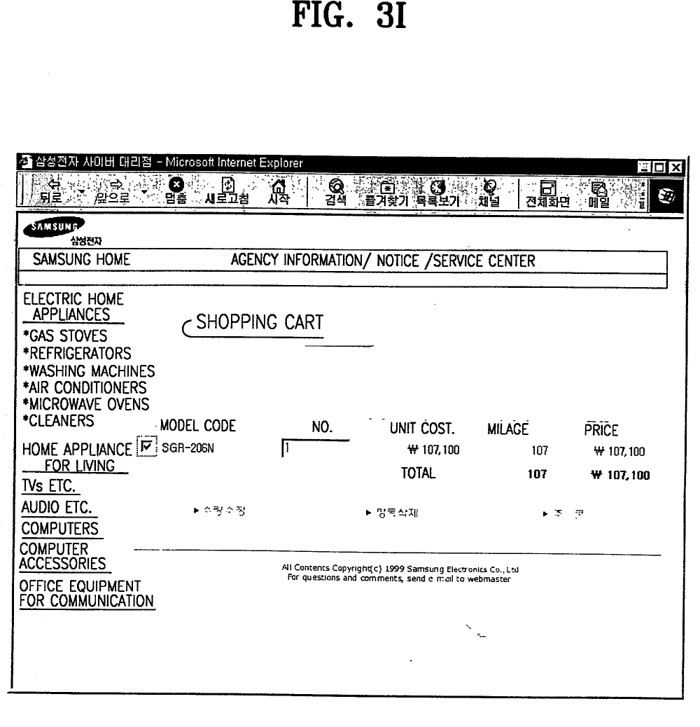

Using the customer web browser 40, a customer who wants to buy a product in the integrated Internet shopping mall according to the present invention, can access the home page provided by the cyber agency connecting unit 11 of the shopping mall web server 10. When, using the customer web browser 40, the customer selects “cyber agency” 300 which is shown in FIG. 3A, a map, in which regions of actual locations of agencies are classified, is displayed as shown in FIG. 3B. When the customer selects the region in which the agency the customer wants is located, the list of agencies located in the region is displayed as shown in FIG. 3C. Therefore, when the customer selects, through the customer web browser 40, a region such as Kyungsang Namdo 310 on the map displayed by the cyber agency connecting unit 11, hyper links of a cyber agency web server 12 belonging to the region are displayed as an agency list 320. The customer can select and access the cyber agency web server 12 he wants in step 210, by clicking the cyber agency 330.

Then, the selected cyber agency web server 12 inquires about agency product information corresponding to the cyber agency, to the agency product information database 16, and provides the information to the customer web browser 40 exemplarily displayed in FIG. 3D. Therefore, in the screen of FIG. 3D, only those products, such as washing machine 340, that are sold in the cyber agency, are displayed. When the customer selects “notices” 350 which is shown in FIG. 3D, the list of notices 360 managed by the agency, as shown in FIG. 3E, is displayed on the customer web browser 40. When the customer selects an item he wants, such as 370, notices 380 as shown in FIG. 3F are displayed on the customer web browser 40. When the customer selects an item from the products the agency sells, only those products of models that are sold in the cyber agency, that is, the actual agency corresponding to the cyber agency, are displayed as in FIG. 3G. At this time, when the customer selects a product he wants to buy such as 390, the cyber agency web server 12 links the detailed product information displaying unit 13. Then, after querying the detailed product information database 17, the detailed product information displaying unit 13 provides detailed product information, including the option to add the item to the customers shopping cart 400, shown in FIG. 3H, to the customer web browser 40 in step 220.

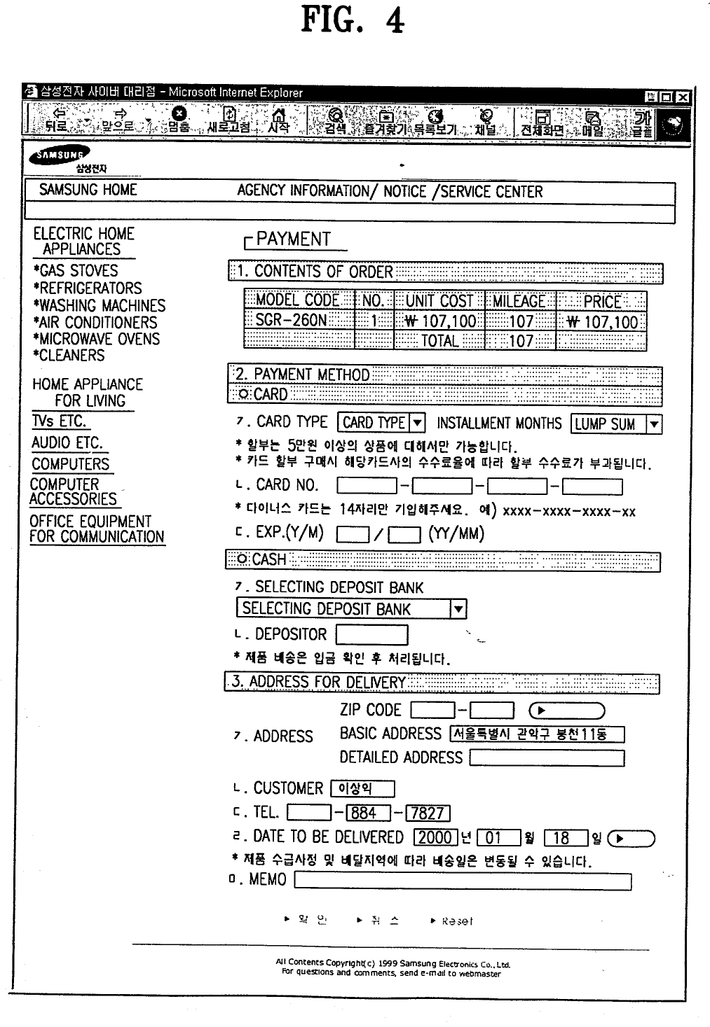

When the customer selects a product, which he wants to buy, in the product list shown in FIG. 3G, the customer order handling unit 14 displays the screen shown in FIG. 31, through the customer web browser 40, and the customer web browser 40 receives order information from the customer and provides it to the customer order handling unit 14. The customer order handling unit 14 adds on the received customer order, creating or modifying the customer shopping cart 410 in the order information database 18. The payment server 20 displays the screen, shown in FIG. 4, through the customer web browser 40. The payment server may provide payment information 500 to the customer. The customer web browser 40 receives payment information from the customer and provides it to he payment server 20 in step 230. Referring to FIG. 4, payment information input by the customer includes information on the payment method 510 and address for delivery 520.

The payment server 20 submits payment information, received from the customer web browser 40, to financial institutions, and when there is no problem, makes the order information stored in the order information database 18 as paid order information.

Then, when the agency, using the agency web browser 50, selects “content of order product” 510, the agency connecting unit 15 provides paid order information 690, as shown in FIG. 5D, to the agency web browser 50 in step 250. Then, the agency delivers the product to the customer according to the paid order information in step 260.

Meanwhile, when the agency cannot deliver the product according to the paid order information, the agency connecting unit 15 receives information indicating that the agency cannot deliver the product, through the agency web browser 50. Then, the shopping mall web server 10 changes the paid order information for a second agency that has the product to be delivered to the customer. On the request of the agency web browser of the second agency, the shopping mall web server 10 sends changed paid order information to the agency web browser of the second agency through the Internet. The second agency delivers the product to the customer according to the changed paid order information.

Meanwhile, the embodiment of the integrated Internet shopping mall management method according to the present invention can be written as a program. The shopping mall management method may be embodied in a general purpose digital computer by running the program from a computer usable recording medium, including but not limited to storage media such as magnetic storage media (e.g., ROM's, floppy disks, hard disks, etc.), optically readable media (e.g., CD-ROMs, DVDs, etc.) and carrier waves (e.g., transmissions over the Internet). Hence, the present invention may be embodied as a computer usable recording medium.

The recording medium includes a program code which operates, in a computer, a module receiving agency product information of each agency, from the agency web browsers corresponding to a plurality of agencies, through the Internet; a module sending the list of products which the cyber agency, selected by the request of the customer web browser among the plurality of cyber agencies corresponding to the plurality of agencies, wants to sell, through the Internet; a module receiving product order information and payment information from the customer web browser through the Internet, and handling payment for the ordered product; and a module for, on request from the agency web browser, providing paid order information for the corresponding agency, to the agency web browser through the Internet.

The recording medium can further include a program code operating in a computer a module retrieving detailed information on the product selected by the request of the customer, from the detailed product information database, and providing the information to the customer web browser through the Internet.

Those functional modules implementing the present invention, which were described above, can be easily achieved by programmers in the field the present invention belongs to.

The present invention gives advantages in establishing a market demand compared to managing a centralized shopping mall, because it enables provisioning of services appropriate for regional characteristics, to customers of various regions.

Also, compared to the case in which each agency manages its own web servers, maintenance and management cost is lower thanks to sharing a system for customer management, product management, order/payment handling, and when inventory in an agency cannot meet orders, then other agencies are easily linked to meet the orders.

So far, exemplary embodiments of the present invention has been explained. The present invention is not restricted to the above-described embodiments, and many variations are possible within the spirit and scope of the present invention, which is clear to the skilled person in the technology field the present invention belongs to. Therefore, the scope of the present invention is not determined by the description but by the accompanying claims.

What is claimed is:

1. An integrated Internet shopping mall management system wherein product order information is received at a cyber agency shopping mall corresponding to an offline agency which a customer selects, and the offline agency delivers the ordered product, the shopping mall management system comprising:
a customer web browser that receives product order information and payment information from the customer and provides the product order information and the payment information through an Internet;
an agency web browser that receives agency product information from an agency and provides the agency product information through the Internet, and receives paid order information through the Internet and displays the paid order information;
a shopping mall web server that forms a cyber agency shopping mall for each of a plurality of agencies; provides the agency product information received from the agency web browsers, corresponding to respective cyber agency shopping malls, to the customer web browser; and receives the order information from the customer web browser through the Internet; and
a payment server that receives order information from the shopping mall web server and, after receives the payment information from the customer web browser through the Internet, handling the payment information for the order.

2. The integrated Internet shopping mall management system of claim 1, wherein the plurality of cyber agencies are divided according to regions in which each offline agency is actually located such that, when the customer selects one of the regions in a map displayed by the cyber agency connecting unit through the customer web browser, the hyper links of all the cyber agency web servers related to the region are displayed, and the customer is enabled to select the cyber agency web server corresponding to the offline agency the customer wants.

3. An integrated Internet shopping mall server system providing web services in an environment connected to an Internet, the server system comprising:
an agency connecting unit receiving agency product information from an agency web browser through the Internet, and providing paid order information to the agency web browser through the Internet;
a plurality of cyber agency web servers corresponding to a plurality of offline agencies, that, after receiving the agency product information from the agency connecting unit, provide the information to a connected customer web browser;
a customer order handling unit receiving order information from the customer web browser; and
a payment server receiving payment information from the customer web browser and handling the payment information for the order.

4. The server system of claim 3, further comprising:
a cyber agency connecting unit having at least one hyper link corresponding to at least one web page provided by the plurality of cyber agency web servers, and that connects one of the cyber agency web servers decided by selection information received from the customer web browser, to the customer web browser.

5. The server system of claim 3, wherein the agency product information includes at least one of a list of products each agency wants to sell and a notice each agency gives to customers.

6. The server system of claim 3, further comprising:
a detailed product information database that stores detailed information of all products the plurality of agencies want to sell; and
a detailed product information displaying unit that provides detailed information retrieved from the detailed product information database, to the customer web browser.

7. The server system of claim 3, wherein the plurality of cyber agencies are divided according to regions in which each agency is actually located such that, when a customer selects one of the regions in a map displayed by the cyber agency connecting unit through the customer web browser, the hyper links of all the cyber agency web servers related to the region are displayed, and the customer is enabled to select the cyber agency web server corresponding to the offline agency the customer wants.

8. An integrated Internet shopping mall management method wherein product order information is received at a cyber agency shopping mall corresponding to an offline agency, which a customer selects, receives product order information, and a selected one of the plurality of agencies delivers an ordered product, the shopping mall management method comprising:
receiving, through the Internet, agency product information of the agencies from an agency web browser corresponding to each agency;
providing, on request of a customer web browser, agency product information of the selected agency to the customer web browser through an Internet;
receiving product order information and payment information from the customer web browser through the Internet, and handling payment for the order; and
on request of the agency web browser, providing paid order information of the corresponding agency, to the agency web browser through the Internet.

9. The management method of claim 8, wherein the providing further comprises:
displaying at least one hyper link corresponding to a web page provided by a selected one of the plurality of cyber agency web servers;
providing, on request of the customer web browser, a list of products the selected agency wants to sell, to the customer web browser through the Internet; and
retrieving, on request of the customer web browser, detailed information on the selected product from a detailed product information database and then providing the detailed information to the customer web browser through the Internet.

10. The management method of claim 8, further comprising:
delivering, from the agency, the product to the customer according to the paid order information.

11. The management method of claim 8, further comprising:
receiving, when the agency cannot deliver the product according to the paid order information, an information indicating that the agency cannot deliver the product, through the agency web browser;
changing the payment handling information to a changed paid order information for a second selected one of the agencies that has the product to be delivered, and, on request of the agency web browser of the second agency, providing the changed paid order information to the agency web browser of the second agency through the Internet; and
delivering, from the second agency, the product to the customer according to the changed paid order information.

12. The management method of claim 8, further comprising dividing the plurality of cyber agencies according to regions in which each agency is actually located such that, when a customer selects a region in a map through the customer web browser, the hyper links of all the cyber agency web servers related to the region are displayed, and the customer is enabled to select the cyber agency web server corresponding to the offline agency the customer wants.

13. A computer readable recording medium having recorded a computer program of an integrated Internet shopping mall server wherein product order information is received at a cyber agency shopping mall corresponding to a selected one of a plurality of offline agencies, which a customer selects, and agencies, one of which corresponds to the selected cyber agency, delivers an ordered product, wherein the server program comprises:
a module that receives, through an Internet, product information for the agencies from agency web browsers corresponding to the plurality of agencies;
a module that provides a list of products, which the selected cyber agency wants to sell, to the customer web browser through the Internet;
a module that receives product order information and payment information from the customer web browser through the Internet, and handles a payment for the product order information and the payment information; and
a module that, on request of the agency web browser of the corresponding one agency, provides a paid order information of the corresponding one agency, to the agency web browser of the corresponding one agency through the Internet.

14. The recording medium of claim 13, wherein the server program further comprises:
a module that, on request of the customer web browser, retrieves a detailed information on the selected product from the detailed product information database, and provides the information to the customer web browser through the Internet.

15. An integrated Internet shopping mall management system comprising:
a shopping mall server that provides a cyber agency shopping mall for a plurality of agencies, comprising
a customer portion that provides product information and receives a product order and payment information from a customer; and
an agency portion that receives the product information from the plurality of agencies over an Internet and provides paid order information; and
a payment server that receives the product order and the payment information from the shopping mall server and handles the payment information for the product information and sends paid order information to the shopping mall server.

16. The integrated Internet shopping mall management system of claim 15, further comprising:
a hyper link corresponding to a web page provided by one of the agencies, that connects the customer to the web page provided by the agency when the hyper link is selected.

17. The integrated Internet shopping mall management system of claim 15, further comprising:
a detailed product information database, maintained by at least one of the plurality of agencies, that stores detailed information about the products the plurality of agencies wants to sell; and
a detailed product information unit that provides the detailed product information retrieved from the detailed product information database, to the shopping mall server.

18. The integrated Internet shopping mall management system of claim 15, wherein the product information includes at least one of a list of products the one of the agencies wants to sell and a notice from one of the agencies.

19. An apparatus for conducting commerce, comprising:
an agency product information database, maintained by an agency, containing at least one of product information, detailed product information and an agency notice to customers;
an agency information handling unit that provides information from the agency product information database to at least one integrated shopping mall over an Internet, the integrated shopping mall providing the information to a customer, accepting a customer order accepting payment information and providing the payment information to a payment processing unit; and
a paid order handling unit that accepts the order from the integrated shopping mall and the payment information from the payment processing unit.
